(19) United States
(12) Patent Application Publication
(10) Pub. No.: US 2008/0077777 A1
(43) Pub. Date: Mar. 27, 2008

(54) Register renaming for instructions having unresolved condition codes

(75) Inventors: Norbert Bernard Eugene Lataille, Le Cannet (FR); Melanie Vincent, Grasse (FR)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/526,212

(22) Filed: Sep. 25, 2006

(51) Int. Cl. G06F 9/30

(52) U.S. Cl. 712/217

(57) ABSTRACT

Register renaming logic is disclosed that is operable to map registers from an architectural set of registers to registers within a physical set of registers, said architectural set of registers being registers specified by instructions within an instruction set and said physical set of registers being registers within a processor for processing instructions of said instruction set. The register renaming logic comprises: a first data store operable to store a register renaming table, said register renaming table comprising renaming values for mapping registers from said architectural set of registers to registers in said physical set of registers; a second data store operable to store further renaming values for at least one architectural register; said renaming logic being operable in response to detection of a decoded instruction that has an unresolved condition code associated with it and that is operable when processed to modify a data value within at least one register, to generate and to store at least one renaming value for said at least one register appropriate to either said instruction condition code being fulfilled or said instruction condition code not being fulfilled in said second data store.

### BACKGROUND OF THE INVENTION

1. Field of the Invention

The field of the invention relates to data processing and in particular to register renaming in a CPU.

2. Description of the Prior Art

It is known to provide processors which process instructions from an instruction set specifying an architectural set of registers using a physical set of registers that is larger than the architectural set. This is a technique that has been developed to try to avoid resource conflicts due to instructions executing out of order in the processor. In order to have compact instruction encodings many processor instruction sets have a small set of register locations that can be directly named. These are often referred to as the architecture registers and in many ARM® (registered trade mark of ARM Cambridge UK) RISC instruction sets there will be 32 architecture registers.

When instructions are processed different instructions take different amounts of time. In order to speed up execution times, processors may have multiple execution units, or may perform out of order execution. This can cause problems if the data used by these instructions is stored in a very limited register set as a value stored in one register may be overwritten before it is used by another instruction. This leads to errors. In order to address this problem it is know for some processing cores to perform processing using more registers than are specified in the instruction set. Thus, for example, a core may have 56 physical registers to process an instruction set having 32 architecture registers. This enables a core to store values in more registers than is specified by the instruction set and can enable a value needed by an instruction that takes a long time to be executed to be stored in a register not used by other neighbouring instructions. In order to be able to do this the core needs to “rename” the registers referred to in the instruction so that they refer to the physical registers in the core. In other words an architectural register referred to in the instruction is remapped onto a physical register that is actually present on the core. Details of known ways of doing this can be found in “register renaming—Wikipedia” at http://en.wikipedia.org/wiki/Register renaming.

Renaming of the registers is generally done using a renaming table which maps registers from the architectural set of registers to registers in the physical set for a particular instruction. As instructions are being executed out of order and renaming occurs early in the pipeline then it may be that an instruction dependent on a condition code appears at the renaming table prior to the condition code being resolved. This has previously resulted in the processor being stalled until the condition has been resolved this is clearly very inefficient.

### SUMMARY OF THE INVENTION

A first aspect of the present invention provides register renaming logic operable to map registers from an architectural set of registers to registers within a physical set of registers, said architectural set of registers being registers specified by instructions within an instruction set and said physical set of registers being registers within a processor for processing instructions of said instruction set, said register renaming logic comprising: a first data store operable to store a register renaming table, said register renaming table comprising renaming values for mapping registers from said architectural set of registers to registers in said physical set of registers; a second data store operable to store further renaming values for at least one architectural register; said renaming logic being operable in response to detection of a decoded instruction that has an unresolved condition code associated with it and that is operable when processed to modify a data value within at least one register, to generate and to store at least one renaming value for said at least one register appropriate to either said instruction condition code being fulfilled or said instruction condition code not being fulfilled in said second data store.

The present invention recognises that there is a potential problem if an instruction is to have registers renamed and yet at the point of renaming how the instruction is to be processed is not yet determinable as the instruction is a conditional instruction whose condition code has yet been resolved. Rather than stalling the processor the problem is addressed by providing an additional data store to store further renaming values. One of the data stores can then be populated for the condition code pass case and the other for the condition code fail case. This means that although only a little extra information is stored, this is sufficient to enable the processor to execute correctly once the condition code has been resolved. This is because register remapping for both it passing and failing is stored and this information can be easily accessed and used to overwrite the renaming table as required.

In some embodiments, said register renaming logic is operable to generate at least one renaming value for said at least one register appropriate to said instruction condition code being either fulfilled or not fulfilled and to store said at least one renaming value in either said first data store or said second data store, said other data store storing said at least one renaming value appropriate to another condition result.

Thus, a register renaming value appropriate to either the pass or fail code may be stored in the second data store while the first data store is left unchanged, or a register renaming value appropriate to either the pass or fail code may be stored in the first data store and the second data store is left unchanged.

It is sufficient to store one extra renaming value, per register that is to be modified by the instruction, and this is generally done by writing a renaming value to the second data store for the condition pass case. However, a value can be written to either data stores for either the condition pass or fail case, with the other data store being left untouched. Provided information is stored for both scenarios there will be sufficient information for the processor to process the instruction stream correctly once the condition has been resolved.

In some embodiments, the apparatus is configured so that the register renaming logic always selects the second data store for a condition code being fulfilled, for example, and always the renaming table for the other condition. In other embodiments, the register renaming logic is operable to select which of the data stores to store said renaming values in.

The amount of storage space required for the second data store is preferably kept as low as possible. Thus, in some embodiments it is possible for the renaming logic to look at how many decoded instructions lying close to each other in the instruction stream have the same or opposite condition codes and to select the second data store as storing values relating to the condition not being fulfilled if most of the instructions have the same condition code, and to it being fulfilled if most have the opposite condition code. This helps to reduce the amount of size required for the second data store.

In some embodiments, said register renaming logic is operable to receive a signal from said processor indicating that said condition code has been resolved and whether said condition has been fulfilled or not, and in response to said signal said register renaming logic is operable to store said at least one renaming value for said at least one register appropriate to said condition code result in said first data store and to delete said other at least one renaming value.

When the condition code has been resolved, the register renaming logic can update the first data store which is in effect the register renaming table with the correct information. The processor can then proceed in the normal way and the correct results will be obtained.

In some embodiments, said register renaming logic is operable in response to receiving a subsequent decoded instruction having a same unresolved condition code as said received decoded instruction with an unresolved condition code to store a renaming value for said condition being fulfilled in said same data store as said previous instruction stored said renaming value for said condition being fulfilled.

Embodiments of the present invention, in effect create two parallel worlds one of them being the condition fulfilled world and the other the condition not fulfilled world. Subsequent conditional instructions having the same condition as the previous unresolved condition can be processed in the appropriate world. Thus, if the condition was an equal condition all equal instructions could store their register renaming values in the second data store for example where all not equal ones could do it in the first data store. As these instructions are only executed if these conditions are fulfilled then parallel worlds can operate correctly. When the condition is resolved then it is known which of the parallel worlds was in fact the correct one and this can be used to update the renaming table. Thus, register remapping can be performed without stalling the processor for conditional code instructions that are not resolved with only the addition of a small additional data storage requirement.

In some embodiments, said register renaming logic is operable in response to receiving a subsequent decoded instruction having an opposite unresolved condition code to said received decoded instruction with an unresolved condition code to store a renaming value for said condition being fulfilled in a different data store to a data store that said previous instruction stored said renaming value for said condition being fulfilled.

Similarly for unresolved opposite condition codes then the two parallel worlds can also be used to continue processing this instruction, the correct world being selected later.

In some embodiments, said register renaming logic is operable in response to receiving a subsequent decoded instruction having no condition code to duplicate said decoded instruction to produce a corresponding decoded instruction having said condition code and a corresponding decoded instruction having said opposite condition code.

While these two worlds are unresolved and are operating, a further instruction that is not conditional upon the same condition code will not know which of the two worlds is correct and therefore which to use. However, if it is an unconditional instruction then this in effect is the same as being two instructions one being dependent on the condition code being fulfilled and the other being dependent on the condition code not being fulfilled. Thus, two instructions can be produced and as it is known how to deal with each of those two instructions in the parallel worlds, register remapping can be performed for each of these instructions and once again processing can proceed without the processor being stalled.

In some embodiments, said register renaming logic is operable in response to receiving a subsequent decoded instruction having no condition code to issue a control signal to stall said processor and not to produce said renaming table until said condition code has been resolved.

It may be that it is considered too expensive in processor power to produce two instructions and thus, the processor is stalled until the condition is resolved.

In some embodiments, said register renaming logic is operable in response to receiving a subsequent decoded instruction having a different unresolved condition code to said received decoded instruction with an unresolved condition code and operable to modify a different architectural register, to generate and to store at least one renaming value for said at least one register appropriate to either said different condition code being fulfilled or said instruction condition code not being fulfilled in said second data store, and to store associated with each entry in said second data store an indication of which condition code said renaming values relate to.

Instructions dependent on different condition codes to the one already being considered can be processed provided they do not remap the same architectural registers. It is sufficient to store these in the second and first data store as for the other condition code with the condition codes marked next to them. Thus, the second data store might store three register remappings relating to instructions conditional on a and b being equal for example and two remappings relating to instructions conditional on d being greater than c. This is fine as long as the same architectural registers are not remapped. If the instructions use the same architectural registers than clearly errors can be produced unless some of the conditions are resolved thus if this is the case the processor will need to stall.

A further aspect of the present invention provides a data processing apparatus comprising: a decoder operable to receive a stream of instructions from an instruction set and decode said instructions; register renaming logic according to a first aspect of the present invention operable to receive said stream of decoded instructions from said decoder; a physical set of registers operable to store data values being processed by said data processing apparatus; and a processor operable to receive said decoded instructions from said register renaming logic and to process said decoded instructions.

A yet further aspect of the present invention provides a method of mapping registers from an architectural set of registers to registers within a physical set of registers using a register renaming table, for a decoded instruction having an unresolved condition code, said architectural set of registers being registers specified by instructions within an instruction set and said physical set of registers being registers within a processor for processing instructions of said instruction set, said register renaming table comprising renaming values for mapping registers from said architectural set of registers to registers in said physical set of registers, said method comprising the steps of: in response to detection of a decoded instruction that has an unresolved condition code associated with it and that is operable when processed to modify a data value within at least one register, generating and storing at least one renaming value for said at least one register appropriate to either said instruction condition code being fulfilled or said instruction condition code not being fulfilled in a data store different to a data store storing said renaming table.

A still further aspect of the present invention provides means for renaming registers so as to map registers from an architectural set of registers to registers within a physical set of registers, said architectural set of registers being registers specified by instructions within an instruction set and said physical set of registers being registers within a processor for processing instructions of said instruction set, said means for renaming registers comprising: a first means for storing data operable to store a register renaming table, said register renaming table comprising renaming values for mapping registers from said architectural set of registers to registers in said physical set of registers; a second means for storing data operable to store further renaming values for at least one architectural register; said means for renaming registers being operable in response to detection of a decoded instruction that has an unresolved condition code associated with it and that is operable when processed to modify a data value within at least one register, to generate and to store at least one renaming value for said at least one register appropriate to either said instruction condition code being fulfilled or said instruction condition code not being fulfilled in said second means for storing data.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically shows a data store 10 for storing a renaming table and a further data store for storing a condition block;

FIG. 2 shows an example stream of instructions and corresponding stored values for the renaming table and further data store of FIG. 1;

FIG. 3 shows a different example to FIG. 2; and

FIG. 4 shows a portion of a data processing apparatus according to an embodiment of the present invention; and

FIG. 5 shows a flow diagram indicating the steps performed by a method according to an embodiment of the present invention.

### DESCRIPTION OF THE PREFERRED EMBODIMENTS

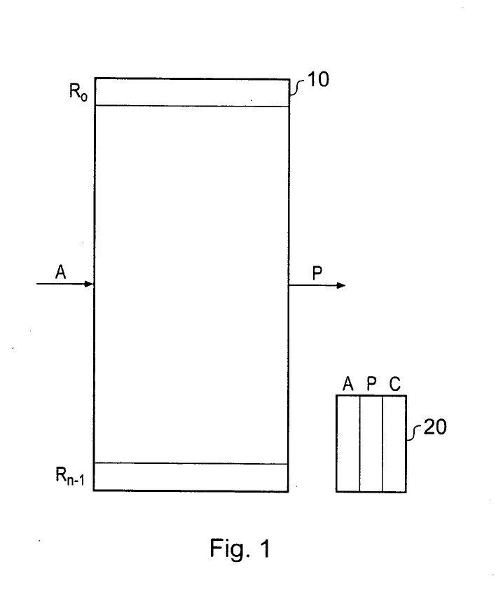

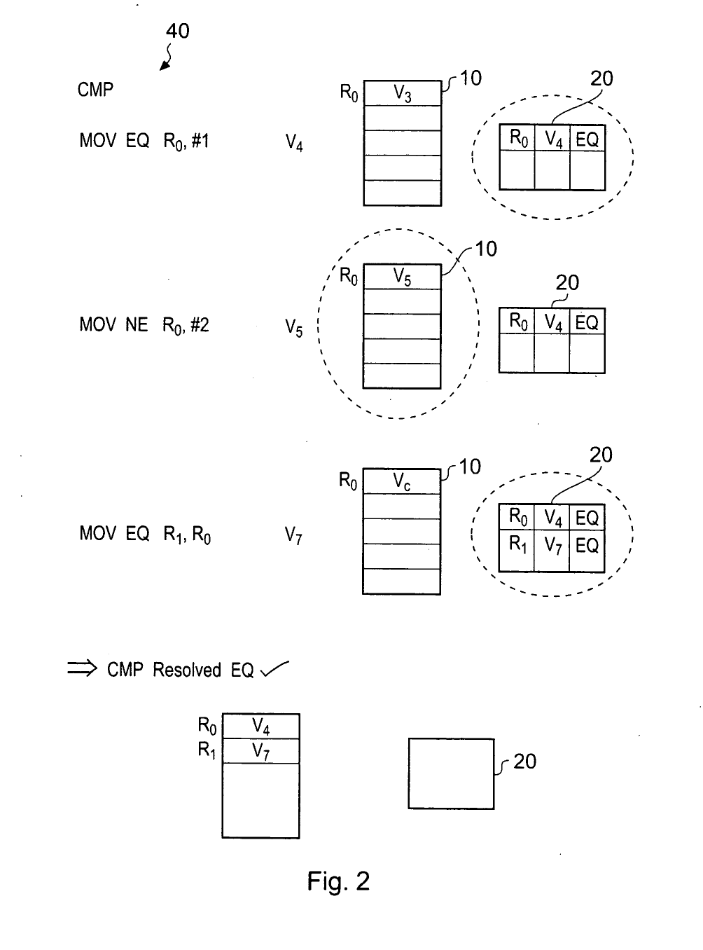

FIG. 1 shows a data store 10 for storing a renaming table and a further data store 20 for storing a condition block relating to remapping data for unresolved condition codes. Renaming table 10 receives a stream of decoded instructions in which the registers are referenced in architectural form. In other words they are referred to as they are in the instruction set and thus there are, for example, 32 registers referred to. Renaming table remaps the architectural registers referred to by the instruction set into physical registers that are actually present on the processor core. Owing to the optimisation processes performed by many processors and also owing to there often being multiple cores within a processor, it is becoming increasingly common to execute instructions out of order. Furthermore, the remapping occurs early in the pipeline, and thus, there may be an instruction arriving at the renaming table with a condition code that has not yet had its condition resolved. In order to address this problem, any register whose stored value is modified by this instruction is in effect remapped or renamed twice. Thus, a mapping for each possible outcome of the condition is given. An example of this is given in FIG. 2. Additional renaming values are stored in a supplementary data store 20. The information stored in this supplementary data store comprises the architectural register, the physical register and the condition code. In effect two parallel worlds are created and as long as subsequent instructions utilising these condition codes or their opposites use the same world up until the point that the condition code is resolved, then the processor can process the instructions correctly without the need to stall and wait for the condition code to be resolved.

FIG. 2 shows an example instruction stream 40 and the values stored in the renaming table in data store 10 and in the supplementary buffer 20 for each value. The circling of the particular table shows which is used in preference for each instruction.

In FIG. 2, a compare instruction is present in the instruction stream and if this is performed after instructions that are dependent on the relative values of the two items being compared then an unresolved condition code scenario is initiated. The first decoded instruction having an unresolved condition code to reach renaming logic in this example is the instruction move the value one to register R₀ if the comparison is equal. Renaming table 10 has register R₀ remapped to physical register V₃ stored in it at this time. In this implementation, this is left as it is and supplemental data store 20 is populated with a line which indicates that R₀ is mapped to physical register V₄ for the condition being fulfilled, i.e. the comparison is equal. In the Figure this table is circled as it is this table that is updated by the renaming logic.

A subsequent instruction is conditional upon the opposite of the condition code i.e. the two items not being equal. This instruction produces register R₀, i.e. it is the value in register R₀ that is modified and the value 2 is stored in this register. Thus, this register needs to be remapped and the renaming logic decides that it should be remapped to physical register V₅. As this instruction is in effect operating in the not equal world then it is the renaming table 10 where this value is stored. Thus, as can be seen in the figure renaming 10 is updated so that R₀ maps to V₅ and it is this remapping information that is updated and thus it is this which is circled.

The following instruction is move the value of register R₀ to register R₁ if the comparison is equal. Thus, it is register R₁ which has its value modified in this case and thus, this needs a new remapping. The renaming logic decides to remap register R₁ to V₇. As we are operating here in “equal world” this information is written into buffer 20 and thus, this table is circled in the Figure.

Renaming logic then receives a signal from the processor that indicates that the comparison has been resolved and that in fact the comparison was equal. At this point, the renaming table 10 is overwritten with the values from the supplementary buffer 20 as supplementary buffer 20 relates to “equal world”, which it is resolved to be and the supplementary buffer 20 can then be flushed of any values stored in it relating to the EQ condition.

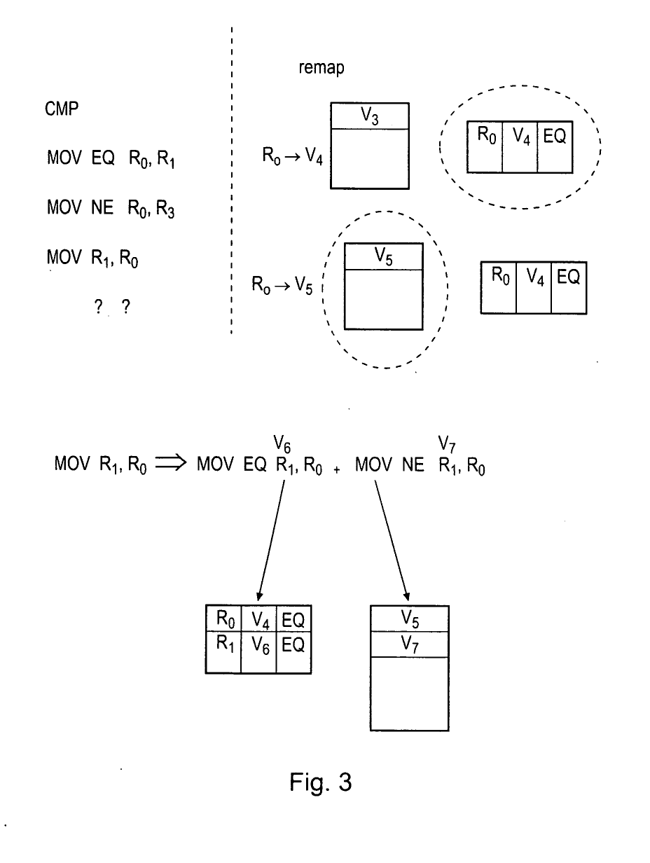

FIG. 3 shows an alternative example. In this example as in the previous one supplementary buffer 20 is chosen to be “equal world” whereas the renaming table is chosen to be not equal world. This is clearly an implementation detail and it could be done the other way around. It is most advantageous to use a renaming table for the world that has the most unresolved conditional code instructions. This is because the renaming table has a fixed size, whereas the size required for the supplementary buffer depends on the number of unresolved conditional code instructions in that world. Clearly it is advantageous to have a small additional buffer 20 and thus this selection is preferable. In some embodiments, selection is made in hardware and cannot be altered, whereas in others the renaming logic has an algorithm which can select according to instructions to be processed.

In the example shown, the first instruction moves the value of register R₁ to register R₀ if the comparison is equal. Thus, register R₀ has a new value stored in it and therefore needs to be renamed or remapped. In this example it is remapped to physical register V₄ and this is stored in supplementary table 20.

The next instruction is operating in not equal world and stores the value from R₃ in register R₀. Thus, R₀ needs to be allocated and is allocated to physical register V₅ and this is stored in the renaming table.

The next instruction is not a conditional code instruction and wants register R₀ to be moved to register R₁ however, we do not know at this point which of the two conditional instructions is correct and thus we don't know what to do. However, the move instruction is in fact the same as move if a condition code is equal plus move if the condition code is not equal and we know how to perform both of these instructions. Thus, we can produce these duplicate instructions and can perform them both one being performed in equal world and the other in not equal world. Thus, an instruction moving register R₀ into register R1 is performed in equal world so register R₁ is allocated to physical register V₆ and table 20 is used to record this, whereas in non-equal world register R₁ is allocated to physical register V₇ and the renaming table is used to record this. Thus, if it turns out that the comparison equal was correct renaming table will have V₄ and R₀ and V₆ as R₁, whereas if it is determined that they weren't equal the renaming table will have R₀ as V₅ and R₁ as V₇ thus, it can be seen that the comparison can be resolved later and still the correct result be attained.

In the examples given, there has only been one condition code shown. However, it should be clear that other condition codes could be considered and these could be written into the tables with an identifier identifying condition codes. This will work as long as the same architectural registers are not specified. If the same architectural registers are specified by two unresolved condition codes then the processor will need to stall until the condition codes are resolved.

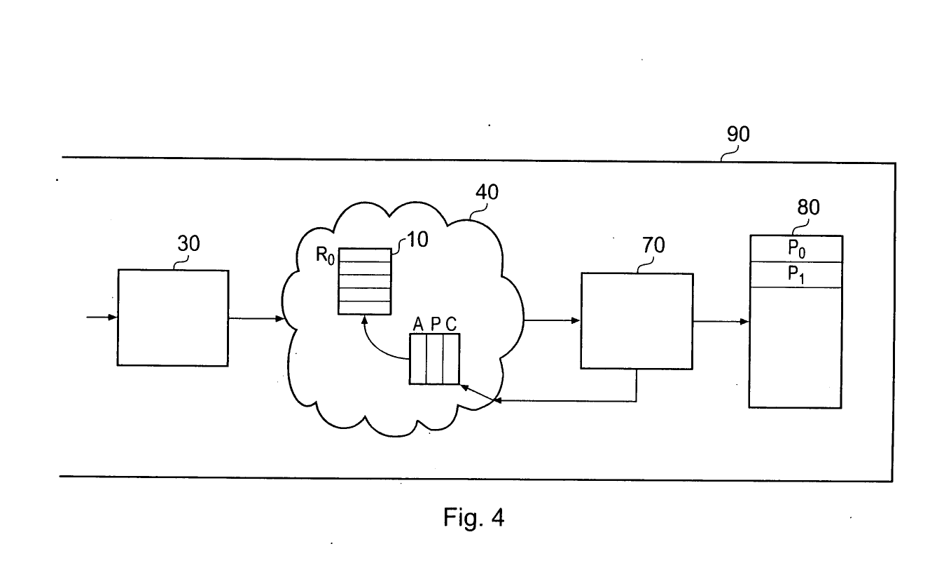

FIG. 4 shows a portion of the data processor 90 comprising an instruction decoder 30 which receives a stream of instructions and produces a stream of decoded instructions. These are sent to register renaming logic 40, which comprises register renaming table 10 and supplementary table 20. If the decoded instruction comprises an unresolved condition code, then renaming logic looks to see if this condition code or its opposite is present in supplementary data store 20. If it is then renaming values for the condition being fulfilled will be stored in either data store 20 or renaming table 10 as appropriate. That is to say in the same table as the same condition code result was stored for the other renaming values. If it is not present then renaming logic can select which table to store any register renaming values in for the condition being fulfilled. The decoded instruction is then sent to execution unit 70 for processing. Execution unit 70 stores data values that it is processing in physical registers 80, the actual register used being dependent on renaming logic 40. When a conditional instruction is resolved by execution unit 70, then this information is sent back to renaming logic 40, where it is used to determine whether supplementary table 20 stored the correct renaming results of renaming table 10 did for this condition. If it was supplementary table 20 then the renaming values relating to this condition are written to renaming table 10. If it was renaming table 10, then the values stored in supplementary buffer 20 relating to this condition code are simply flushed.

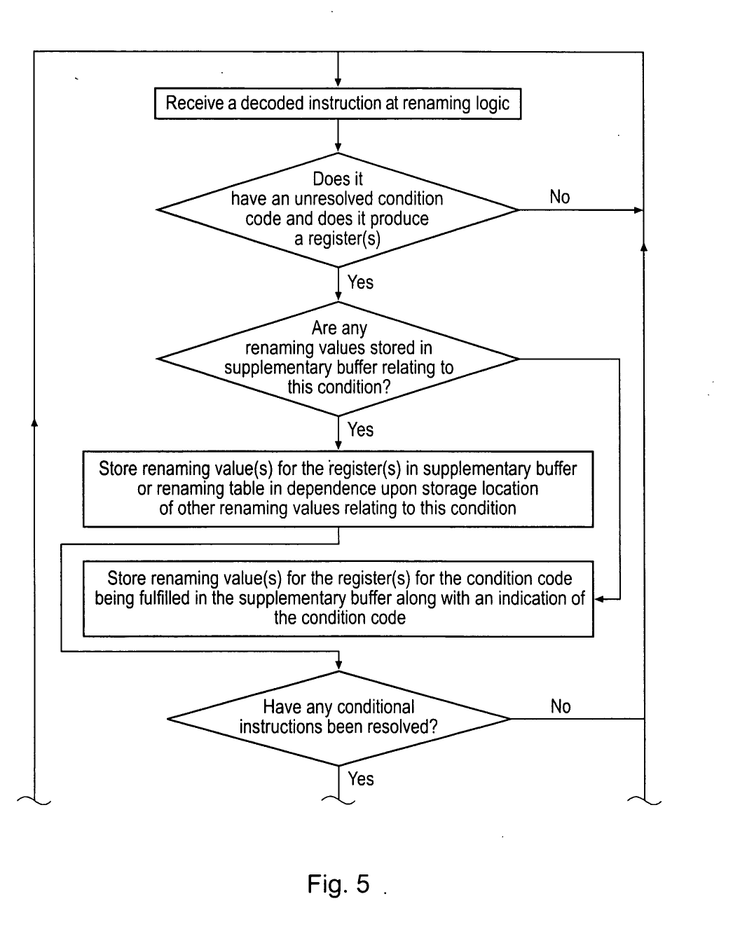

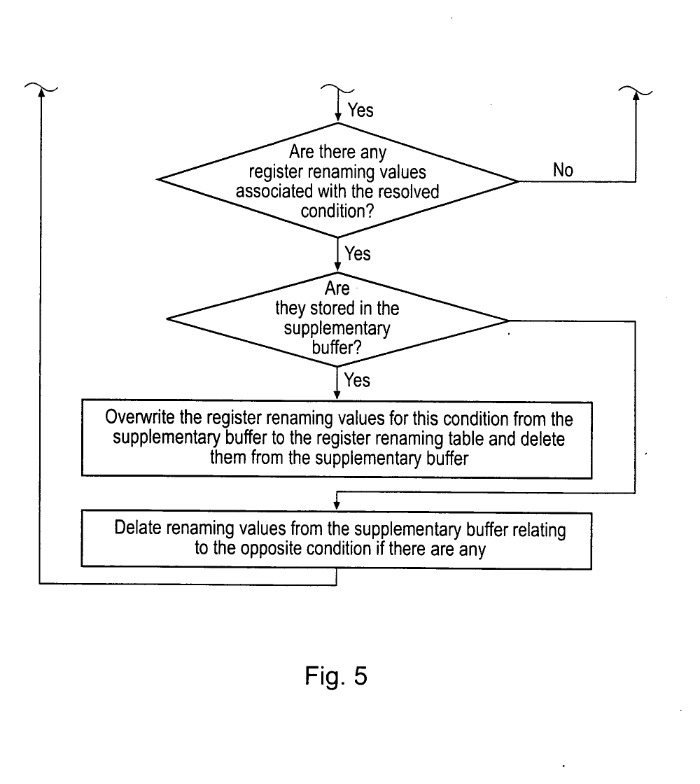

FIG. 5 shows a flow diagram illustrating steps performed in a method according to an embodiment of the present invention. Initially a decoded instruction is received at renaming logic. Renaming logic then determines whether it has an unresolved condition code relating to it and whether it produces a register. That is whether it modifies a value stored in a register. If it doesn't have both of these things, then the renaming logic deals with it in a standard way and looks at the next decoded instruction in the instruction stream. If it does have an unresolved condition code and it does produce a register then the renaming logic then looks to see if there are any renaming values stored in the supplementary buffer 20 of FIG. 4 that relate either to the condition or the to opposite condition of this unresolved condition code. If there are, then the renaming logic takes this into account when deciding where to store the renaming value. In particular, it stores the renaming values in the same data store as the previous values for the same condition code were stored. Thus, in effect two worlds are created one with a particular condition code fulfilled and the other with it not fulfilled. It should be noted that the world where the condition code is not fulfilled is the same as the world where the opposite condition code is fulfilled.

If there are no renaming values stored in the supplementary buffer relating to this condition or its opposite then the renaming logic stores renaming value for the registers for the condition code being fulfilled in the supplementary buffer along with an indication of the condition code. The renaming logic then looks to see if any conditional instructions have been resolved in execution pipeline 70 of FIG. 4. If they have not then it looks again at the next decoded instruction received. If there is a condition that has been resolved then it looks to see if there are any register renaming values associated with the resolved condition or with its opposite stored in supplementary buffer 20. If not then it returns to the next decoded instruction received. If the opposite condition is present in buffer 2 then this indicates that the renaming values are stored in the renaming table and thus the renaming table is correct. Thus, the only thing that needs to be done is that the renaming values from the supplementary buffer relating to the opposite condition need to be deleted as we now know that this opposite condition is not fulfilled.

If there are some register renaming values associated with the resolved condition stored in the supplementary buffer then we know that the register renaming values for these registers are not correct in the renaming table and these values need to be overwritten with values from the supplementary buffer. They can then be deleted from the supplementary buffer.

This description illustrates what happens in the case of instructions with unresolved condition codes at renaming logic. Clearly other instructions received at renaming logic are dealt with in a standard way.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. Register renaming logic operable to map registers from an architectural set of registers to registers within a physical set of registers, said architectural set of registers being registers specified by instructions within an instruction set and said physical set of registers being registers within a processor for processing instructions of said instruction set, said register renaming logic comprising:
a first data store operable to store a register renaming table, said register renaming table comprising renaming values for mapping registers from said architectural set of registers to registers in said physical set of registers;
a second data store operable to store further renaming values for at least one architectural register;
said renaming logic being operable in response to detection of a decoded instruction that has an unresolved condition code associated with it and that is operable when processed to modify a data value within at least one register, to generate and to store at least one renaming value for said at least one register appropriate to either said instruction condition code being fulfilled or said instruction condition code not being fulfilled in said second data store.

2. Register renaming logic according to claim 1, wherein said register renaming logic is operable to generate at least one renaming value for said at least one register appropriate to said instruction condition code being either fulfilled or not fulfilled and to store said at least one renaming value in either said first data store or said second data store, said other data store storing said at least one renaming value appropriate to another condition result.

3. Register renaming logic according to claim 2, said register renaming logic being operable to select which of said data stores to store said renaming values in.

4. Register renaming logic according to claim 1, said register renaming logic being operable to receive a signal from said processor indicating that said condition code has been resolved and whether said condition has been fulfilled or not, and in response to said signal said register renaming logic is operable to store said at least one renaming value for said at least one register appropriate to said condition code result in said first data store and to delete said other at least one renaming value.

5. Register renaming logic according to claim 1, said register renaming logic being operable in response to receiving a subsequent decoded instruction having a same unresolved condition code as said received decoded instruction with an unresolved condition code to store a renaming value for said condition being fulfilled in said same data store as said previous instruction stored said renaming value for said condition being fulfilled.

6. Register renaming logic according to claim 1, said register renaming logic being operable in response to receiving a subsequent decoded instruction having an opposite unresolved condition code to said received decoded instruction with an unresolved condition code to store a renaming value for said condition being fulfilled in a different data store to a data store that said previous instruction stored said renaming value for said condition being fulfilled.

7. Register renaming logic according to claim 6, said register renaming logic being operable in response to receiving a subsequent decoded instruction having no condition code to duplicate said decoded instruction to produce a corresponding decoded instruction having said condition code and a corresponding decoded instruction having said opposite condition code.

8. Register renaming logic according to claim 1, said register renaming logic being operable in response to receiving a subsequent decoded instruction having no condition code to issue a control signal to stall said processor and not to produce said renaming table until said condition code has been resolved.

9. Register renaming logic according to claim 1, said register renaming logic being operable in response to receiving a subsequent decoded instruction having a different unresolved condition code to said received decoded instruction with an unresolved condition code and operable to modify a different architectural register, to generate and to store at least one renaming value for said at least one register appropriate to either said different condition code being fulfilled or said instruction condition code not being fulfilled in said second data store, and to store associated with each entry in said second data store an indication of which condition code said renaming values relate to.

10. Register renaming logic according to claim 1, wherein
said register renaming logic is operable to receive a stream of decoded instructions, said decoded instructions being instructions from said instruction set, and to populate said register renaming table with renaming values appropriate for each received decoded instruction; and
to rename any registers associated with said received decoded instructions in dependence upon said renaming values within said renaming table;

11. A data processing apparatus comprising:
a decoder operable to receive a stream of instructions from an instruction set and decode said instructions;
register renaming logic according to claim 1 operable to receive said stream of decoded instructions from said decoder;
a physical set of registers operable to store data values being processed by said data processing apparatus; and
a processor operable to receive said decoded instructions from said register renaming logic and to process said decoded instructions.

12. A data processing apparatus according to claim 11, comprising register renaming logic, said data processing apparatus being operable to resolve a condition relating to a condition code of a decoded instruction and to send a signal indicating said resolution to said register renaming logic.

13. A method of mapping registers from an architectural set of registers to registers within a physical set of registers using a register renaming table, for a decoded instruction having an unresolved condition code, said architectural set of registers being registers specified by instructions within an instruction set and said physical set of registers being registers within a processor for processing instructions of said instruction set, said register renaming table comprising renaming values for mapping registers from said architectural set of registers to registers in said physical set of registers, said method comprising the steps of:
in response to detection of a decoded instruction that has an unresolved condition code associated with it and that is operable when processed to modify a data value within at least one register, generating and storing at least one renaming value for said at least one register appropriate to either said instruction condition code being fulfilled or said instruction condition code not being fulfilled in a data store different to a data store storing said renaming table.

14. Means for renaming registers so as to map registers from an architectural set of registers to registers within a physical set of registers, said architectural set of registers being registers specified by instructions within an instruction set and said physical set of registers being registers within a processor for processing instructions of said instruction set, said means for renaming registers comprising:
a first means for storing data operable to store a register renaming table, said register renaming table comprising renaming values for mapping registers from said architectural set of registers to registers in said physical set of registers;
a second means for storing data operable to store further renaming values for at least one architectural register;
said means for renaming registers being operable in response to detection of a decoded instruction that has an unresolved condition code associated with it and that is operable when processed to modify a data value within at least one register, to generate and to store at least one renaming value for said at least one register appropriate to either said instruction condition code being fulfilled or said instruction condition code not being fulfilled in said second means for storing data.
